(19) United States
(12) Patent Application Publication
(10) Pub. No.: US 2026/0326673 A1
(43) Pub. Date: Oct. 22, 2026

(54) Foldable Seatbelt-Secured Transport and Display System

(71) Applicant: Timothy Ryan Rogers, Bella Vista, AR (US)

(72) Inventor: Timothy Ryan Rogers, Bella Vista, AR (US)

(21) Appl. No.: 19/651,335

(22) Filed: Apr. 17, 2026

Related U.S. Application Data
(60) Provisional application No. 63/790,252, filed on Apr. 17, 2025.

(51) Int. Cl. B60R 7/08

(52) U.S. Cl. CPC B60R 7/085

(57) ABSTRACT

A holder device comprising a foldable sheet material with at least one engagement feature configured to engage with a vehicle seatbelt for lateral stability. The foldable sheet material extends from a vehicle seat into a vehicle footwell to form a vertical support structure that rests on the floor of the footwell. The device includes a plurality of apertures that vertically align when the material is in a folded configuration to receive and support a bouquet in an upright position. This configuration addresses the challenge of transporting full-length flower bouquets without requiring a vase or risking damage to delicate petals. The device provides both vertical and lateral stability during transport, preventing floral arrangements from being crushed or damaged in transit. The foldable sheet material can be manufactured from various materials and may be reconfigurable for use as a freestanding display outside the vehicle.

### FIELD OF INVENTION

The present invention relates to devices for securing and transporting floral arrangements in vehicles. More specifically, the invention pertains to a foldable structure that provides stabilized vertical support for bouquets during vehicular transport without requiring a vase.

### BACKGROUND

The transportation of floral arrangements, particularly full-length bouquets, has long presented challenges for both professional florists and individual consumers. Traditional methods of floral transport often compromise either the integrity of delicate blooms or the aesthetic appeal of the arrangement. When transporting flowers in vehicles, users typically must choose between suboptimal solutions that fail to adequately address the unique requirements of floral transport.

Commercial florists regularly employ specialized transport containers designed primarily for short-stemmed arrangements, which utilize foam casings or cardboard boxes to stabilize vases. While these systems offer certain advantages for commercial transport, they impose significant limitations. Such containers typically accommodate only shortened stems, which can diminish both the quality and longevity of cut flowers. Additionally, these systems often require water in the container during transport, introducing risks of spillage, additional weight, and potential damage to vehicle interiors. The specialized foam blocks utilized by professional florists for full-length arrangements require substantial space, typically occupying an entire vehicle bed, making them impractical for average consumers.

Individual consumers, lacking access to professional transport solutions, often resort to simply laying bouquets horizontally across passenger seats or floorboards. This improvised approach frequently results in damage to delicate petals and blooms, which become bruised or crushed when they come into contact with hard vehicle surfaces during transport. The absence of proper stabilization also allows bouquets to shift during transit, particularly during turns or sudden stops, further increasing the likelihood of damage. The resulting degradation of floral quality can significantly diminish the impact of gifted arrangements and potentially shorten their aesthetic lifespan.

Existing vehicle-mounted floral transport devices have generally failed to address these combined concerns. Prior inventions have typically focused on securing containers to seatbacks or on providing stabilized vase holders that rest on seat cushions. Such approaches fail to utilize the full vertical space available in modern vehicles, thereby limiting their utility for full-length bouquets. Additionally, these devices often lack sufficient lateral stability, allowing movement during cornering or braking that can damage delicate blooms. The predominant reliance on water-filled vases in existing systems introduces further complications, including weight distribution issues and potential for spillage.

US2017028933A1 presents a floral transport container formed from a single sheet of foldable material that secures to a vehicle seat using the seatbelt mechanism. The device features openings to accommodate flower containers and provides stability through its connection to the seatbelt and by resting against the inclined seatback. Notably, the disclosed carrier is designed to rest entirely on the seat surface rather than utilizing the vehicle's footwell space for additional support and stability. This configuration restricts the carrier's ability to properly stabilize full-length bouquets during transportation over varied road conditions. Furthermore, the prior art lacks any provision for secondary functionality outside the vehicle environment, limiting its utility to the singular purpose of in-vehicle transport.

The economic implications of inadequate transport solutions are substantial for both the floral industry and consumers. Professional florists must account for potential transport damage in their business models, often necessitating more robust packaging that increases both material costs and environmental impact. For consumers, the lack of accessible transport solutions may discourage the purchase of premium full-length arrangements, particularly when transportation challenges are anticipated. Furthermore, the disposable nature of many existing commercial transport solutions contradicts growing consumer preference for sustainable, reusable products that minimize environmental impact while maintaining functionality. These combined limitations highlight the need for innovative approaches to floral transport that can protect delicate arrangements while offering practicality for everyday consumers.

It is within this context that the present invention is provided.

### SUMMARY

The present invention relates to a holder device comprising a foldable sheet material with at least one engagement feature configured to engage with a vehicle seatbelt for lateral stability. The foldable sheet material is designed to extend from a vehicle seat into a vehicle footwell and form a vertical support structure that rests on the floor of the footwell. The foldable sheet material includes a plurality of apertures that vertically align when the material is in a folded configuration to receive and support a bouquet.

This invention addresses the challenge of transporting full-length flower bouquets in vehicles without requiring a vase or risking damage to delicate petals. The design allows for secure positioning of bouquets during transport by providing both vertical and lateral stability. The structure is configured to maintain bouquets in an upright position, preventing floral arrangements from being crushed or damaged while in transit.

In some embodiments, the foldable sheet material comprises a first end portion, a middle portion, and a second end portion, all integrally formed from a single sheet of material. This single-piece construction simplifies manufacturing and assembly while providing a cohesive structure that functions effectively as a unit.

In further embodiments, the engagement feature comprises multiple protruding tabs at the first end portion, each including a cutout designed to capture the vehicle seatbelt when installed. This configuration enhances lateral stability by securely attaching the bouquet holder to the seatbelt system.

In yet further embodiments, the first end portion includes a horizontal portion that rests flat on the surface of the vehicle seat. This arrangement distributes weight and provides a stable platform for the bouquet holder when installed in a vehicle.

In some embodiments, the middle portion extends downward from the first end portion and descends into the vehicle footwell. This configuration creates the transition between the seat surface and the footwell area, enabling the vertical support structure to form properly.

In further embodiments, the second end portion includes a securing tab that folds back toward the middle portion and engages with an aperture in the foldable sheet material to lock the device in its folded configuration. This locking mechanism maintains structural integrity during use without requiring additional fasteners.

In yet further embodiments, the middle portion contains multiple secondary fold lines that divide it into at least three sub-portions, which fold relative to each other to create a rigid vertical support structure. This folding arrangement enhances the structural strength of the device when assembled.

In some embodiments, the plurality of apertures includes a first aperture in the middle region of the foldable sheet material and a second aperture in the lower region when the device is folded. This dual-aperture system provides two points of contact for bouquet stems, ensuring secure positioning.

In further embodiments, the first aperture has an sunburst pattern with flexible fingers that adaptively accept stems of various diameters. This design accommodates different bouquet sizes while maintaining a secure grip on the stems.

In yet further embodiments, the second aperture has a circular sunburst pattern with flexible fingers that adaptively accept stems of various diameters. This configuration provides additional flexibility for accommodating different bouquet types.

In some embodiments, the distance between the first and second apertures when folded is predetermined to provide optimal support for standard bouquet configurations. This spacing ensures proper balance and stability for typical floral arrangements.

In further embodiments, the foldable sheet material includes a primary crease line perpendicular to its length, positioned to align with the edge where the vehicle seat meets the footwell. This alignment ensures proper positioning of the device within the vehicle environment.

In yet further embodiments, the primary crease line includes an aperture that receives a securing tab when the device is folded. This feature contributes to the structural stability of the assembled configuration.

In some embodiments, the foldable sheet material is made from materials such as corrugated cardboard, plastic sheeting, paperboard, fiberboard, or combinations thereof. These material options provide flexibility in manufacturing for different use cases and durability requirements.

In further embodiments, the foldable sheet material can be reconfigured from its vehicle use configuration into an easel-like freestanding display stand for use outside a vehicle. This dual-functionality extends the utility of the device beyond vehicle transport.

In yet further embodiments, the easel-like configuration is formed by refolding portions that normally engage with the seatbelt to create a support leg structure. This repurposing of components allows for efficient transformation between configurations.

In some embodiments, the bouquet holder can stand independently without additional support when folded. This self-supporting capability provides convenience during loading and unloading of bouquets.

In further embodiments, the lower portion of the vertical support structure rests flat on the footwell floor to provide vertical stability. This floor contact creates a solid foundation for the structure when in use.

In yet further embodiments, portions of the foldable sheet material include blank space for printed matter, personalization, or advertising. This feature offers customization opportunities for businesses or individuals.

In some embodiments, the foldable sheet material is configured to accept and support a thin vase containing bouquet stems. This adaptation extends the functionality to accommodate alternative floral presentation methods.

### BRIEF DESCRIPTION OF THE DRAWINGS

Various embodiments of the invention are disclosed in the following detailed description and accompanying drawings.

FIG. 1A illustrates an example of the initial step for installing the bouquet holder in a vehicle by positioning it on the passenger seat and securing it with the seatbelt.

FIG. 1B illustrates an example of folding the bouquet holder along the seat edge to extend into the vehicle footwell.

FIG. 1C illustrates an example of securing the bouquet holder structure by tucking the tab into the corresponding slot.

FIG. 1D illustrates an example of the fully assembled bouquet holder in its vehicle configuration, ready to receive a bouquet.

FIG. 1E illustrates an example of the bouquet holder in use with flower stems inserted through the aligned apertures.

FIG. 2A illustrates an example of the first step in converting the bouquet holder to a freestanding display by unhooking it from the seatbelt and preparing to fold at the designated lines.

FIG. 2B illustrates an example of connecting the tabs to form the easel-shaped base of the freestanding display configuration.

FIG. 2C illustrates an example of the completed freestanding easel configuration ready to display a bouquet on a flat surface.

FIG. 3 illustrates an example of the complete unfolded pattern of the bouquet holder showing all fold lines, apertures, tabs, and slots.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The use of spatial terms, such as “under,” “below,” “lower,” “over,” “upper,” etc., is employed for ease of explanation to describe the relationship between elements when the apparatus is in its proper orientation.

The terms “first,” “second,” and the like are used to distinguish different elements or features, but these elements or features should not be limited by these terms. A first element or feature described can be referred to as a second element or feature and vice versa without departing from the teachings of the present disclosure.

The term “foldable sheet material” refers to any flexible material capable of being folded along predetermined lines to create a three-dimensional structure. This includes, but is not limited to, paper-based materials, polymer-based materials, and composite materials. In one example implementation, the foldable sheet material may be a corrugated cardboard sheet with a thickness between 1.5 mm and 4 mm, having sufficient rigidity to support a bouquet weighing up to 4 kilograms while maintaining structural integrity when folded.

The term “engagement feature” refers to any structural element designed to interact with a vehicle seatbelt to provide lateral stability to the bouquet holder. This includes, but is not limited to, tabs, slots, hooks, loops, and clamps. In one example implementation, the engagement feature may comprise two protruding tabs extending 5 cm from the edge of the first end portion, each containing a J-shaped cutout sized to accommodate standard vehicle seatbelts with widths between 4 cm and 6 cm.

The term “vertical support structure” refers to the configuration of the foldable sheet material when properly folded to extend from the vehicle seat into the footwell. This includes, but is not limited to, structures with internal reinforcement folds, interlocking tabs, and self-supporting geometries. In one example implementation, the vertical support structure may comprise a zigzag-folded section with three parallel fold lines spaced 8 cm apart, creating accordion-like pleats that provide increased load-bearing capacity.

The term “apertures” refers to openings in the foldable sheet material designed to accommodate and secure bouquet stems. This includes, but is not limited to, circular openings, oblong openings, sunburst-patterned openings, and slotted openings. In one example implementation, the apertures may be die-cut sunburst patterns with sixteen flexible fingers, the first aperture having dimensions of 8 cm by 4 cm and the second aperture a diameter of 6 cm.

The term “folded configuration” refers to the assembled state of the bouquet holder when ready for use. This includes, but is not limited to, configurations secured by tabs, adhesives, or interlocking structural elements. In one example implementation, the folded configuration may be maintained by a securing tab that extends 4 cm from the second end portion and inserts into a corresponding slot at the first fold line, creating a locked position that maintains structural integrity during use.

The term “vehicle seat” refers to any seating surface within a motor vehicle. This includes, but is not limited to, passenger seats, driver seats, and rear bench seats. In one example implementation, the bouquet holder may be designed primarily for installation on front passenger seats of standard passenger vehicles, with the first end portion dimensioned to cover approximately 25 cm of seat depth.

The term “vehicle footwell” refers to the floor area in front of a vehicle seat. This includes, but is not limited to, front passenger footwells, driver footwells, and rear passenger footwells. In one example implementation, the bouquet holder may be designed to accommodate footwell depths between 30 cm and 45 cm, with the vertical support structure having adjustable fold positions to accommodate this range.

The term “bouquet” refers to an arrangement of cut flowers and/or decorative foliage. This includes, but is not limited to, professional floral arrangements, hand-tied bouquets, and bundled stems. In one example implementation, the bouquet holder may be designed to accommodate standard bouquets with stem diameters between 1 cm and 10 cm when bundled.

### Description of Drawings

The present invention relates to a bouquet holder device designed to facilitate the secure transport of floral arrangements within vehicles. More specifically, the invention provides a solution for transporting full-length flower bouquets without requiring a vase or risking damage to delicate floral components during transit.

Traditional methods for transporting flower bouquets have presented significant limitations. When transported in short vases, flowers must have shortened stems, which reduces both their quality and lifespan. The use of vases with water introduces additional complications including added weight, potential spillage, and transportation challenges. Florists and delivery services typically use specialized vehicles with built-in holders or large foam blocks covering the vehicle bed—solutions unavailable to most consumers. Alternatively, when full-length bouquets are transported by laying them on passenger seats or floorboards, the delicate petals often suffer bruising and damage.

The bouquet holder device of the present invention addresses these limitations through a carefully designed structure that secures bouquets in a vertical orientation during transport. By utilizing a foldable sheet material that extends from the vehicle seat into the footwell, the device creates a vertical support structure that prevents damage while maintaining the integrity of full-length stems. The integration of seatbelt engagement features provides lateral stability, while the vertical support that rests on the footwell floor ensures upright positioning throughout transport.

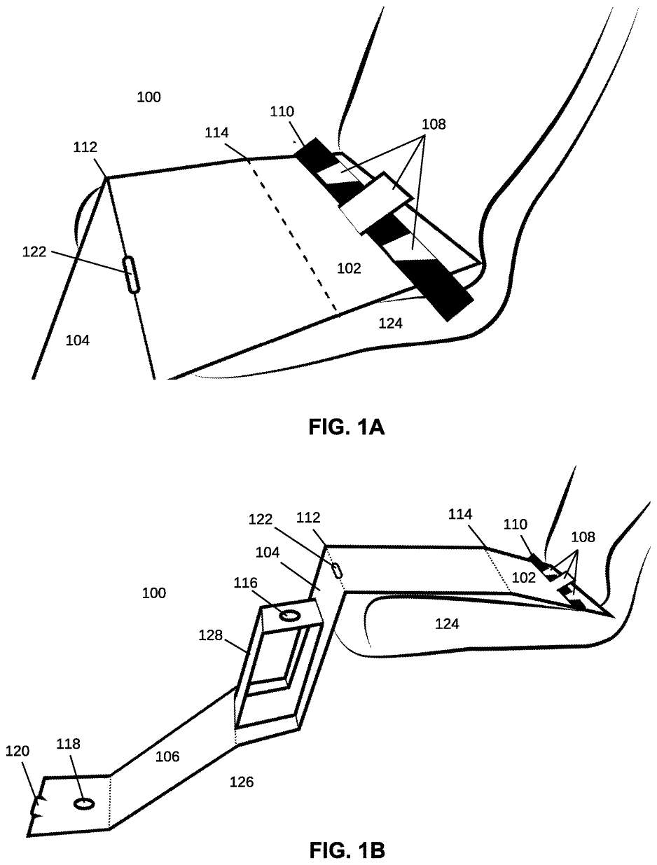

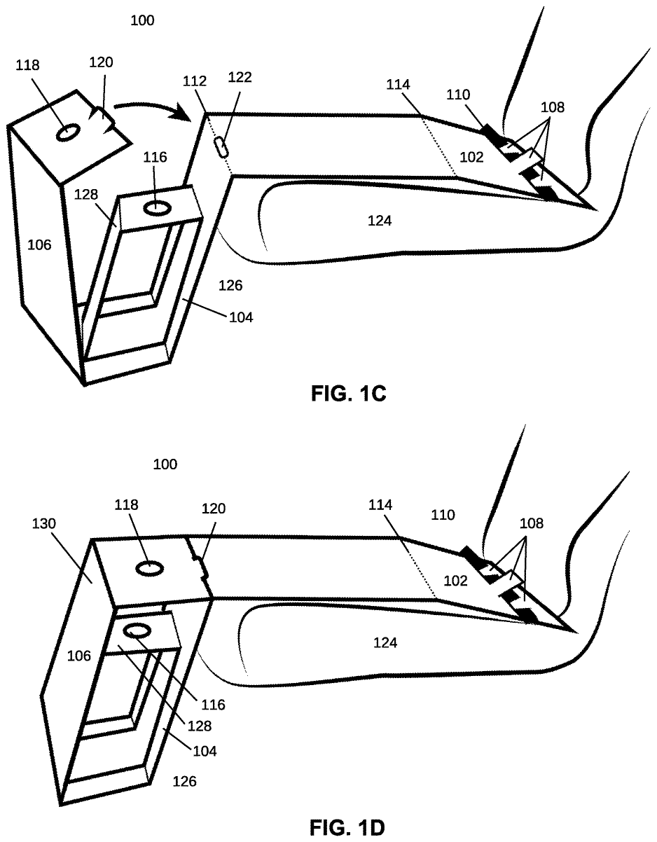

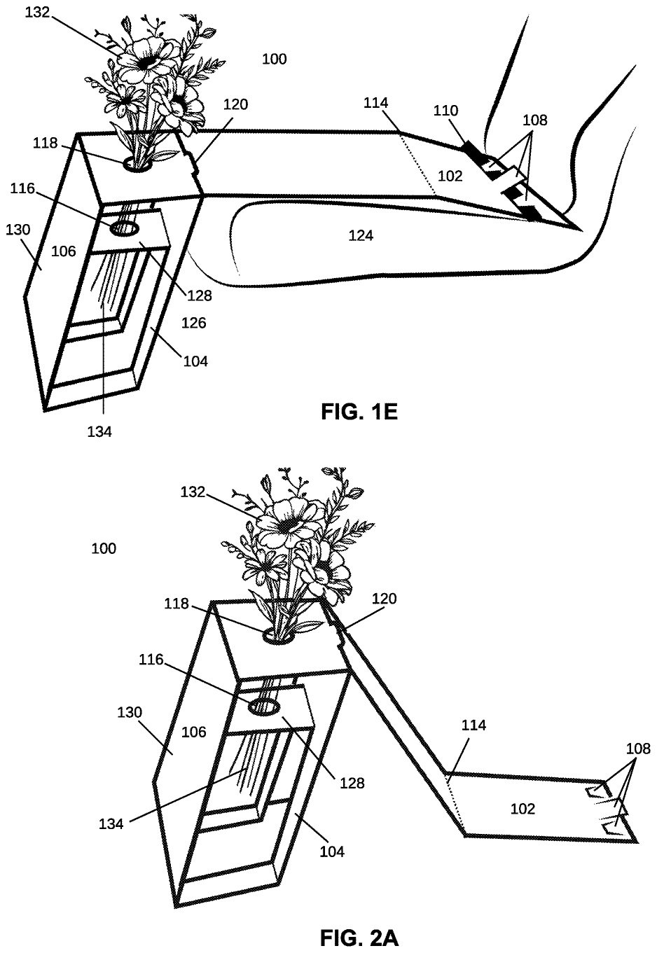

Referring now to the drawings, FIGS. 1A through 1E illustrate the step-by-step process for assembling and installing an example implementation of the bouquet holder device in a vehicle configuration.

FIG. 1A illustrates a first step of the assembly process, wherein the foldable sheet material (100) is positioned on the vehicle seat (124). The first end portion (102) of the foldable sheet material (100) is laid flat on the vehicle seat surface (124). The engagement feature (108), comprising tabs designed to interact with the vehicle seatbelt (110), is visible at the first end portion (102). As shown, the vehicle seatbelt (110) is buckled and the engagement feature (108) is hooked onto the waist strap portion of the seatbelt (110), thereby providing lateral stability to the bouquet holder device. The foldable sheet material (100) is substantially flat with a first fold line (112) positioned at the edge of the seat. A slot (122) is formed in the first fold line (112) for a tab at the second end of the sheet to slot into when the sheet is folded around.

FIG. 1B depicts a second step of the assembly process with the lower parts of the sheet shown. The foldable sheet material (100) is folded along the first fold line (112) at the edge of the vehicle seat (124) where it meets the vehicle footwell. The middle second portion (104) of the foldable sheet material (100) thus extends downward into the vehicle footwell (126). This second portion (104) has lines and an aperture (116) cut into it that allows a support structure (128) to be folded out to form the bottom end of the bouquet support. The support structure (128) forms a base which rests on the floor of the footwell.

A third portion of the sheet (106) which has not yet been folded around rests in the passenger footwell, this third portion has a second aperture (118) that when folded around will form the top of the bouquet support and align with the first aperture (116).

FIG. 1C shows a third step of the assembly process, where the second end of the sheet (106) is folded about the secondary fold line to encase the support structure (128) in the footwell. The securing tab (120) on the second end portion (106) is being moved towards the slot (122) in the first fold line of the foldable sheet material (100).

FIG. 1D illustrates a fourth step of the assembly process, showing the fully assembled bouquet holder device in its folded configuration. The vertical support structure (130) is now completely formed within the vehicle footwell (126), with the securing tab (120) properly engaged with the corresponding slot (122). The first aperture (116) and second aperture (118) in the vertical structure (128) are now aligned vertically to receive and support a bouquet.

FIG. 1E depicts a fifth step, the final step showing the bouquet holder device in active use. A bouquet (132) has been inserted through the vertically aligned first aperture (116) and second aperture (118) in the vertical support structure (130). The flower stems (134) pass through both apertures (116, 118), with the floral arrangement angled slightly toward the vehicle seat (124). This positioning helps prevent damage to the delicate petals by keeping them away from hard surfaces within the vehicle. The entire structure maintains its stability through the combination of the seatbelt (110) engagement at the first end portion (102) and the support structure (128) resting on the floor of the vehicle footwell (126). The bouquet (132) is now secured for transport in a vertical orientation, protecting the integrity of the full-length stems and delicate floral components.

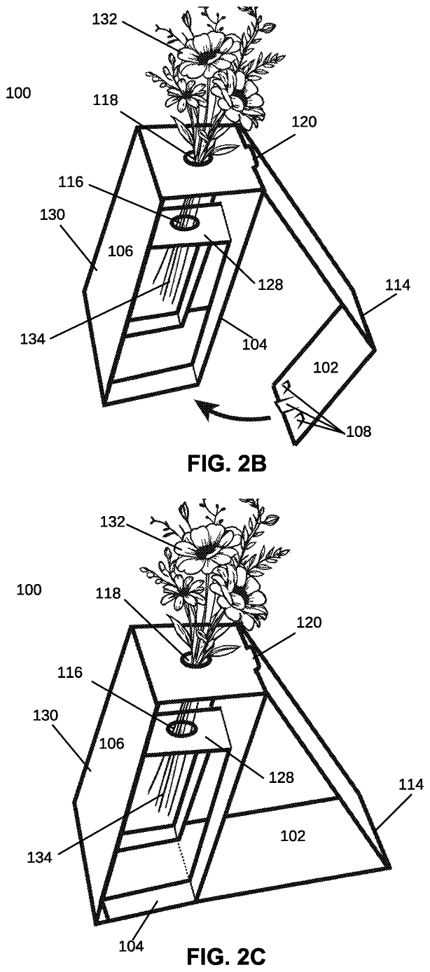

FIGS. 2A through 2C illustrate the step-by-step process for converting the bouquet holder device from its vehicle configuration to a freestanding easel display configuration.

FIG. 2A shows a first step of the conversion process. The foldable sheet material (100) has been removed from the vehicle setting, with the bouquet (132) remaining in place with flower stems (134) inserted through the aligned apertures (116, 118). The engagement features (108) of the first end portion (102) that previously rested on the vehicle seat (124) have been unhooked from the seatbelt (110).

FIG. 2B depicts a second step of the conversion process. The first end portion (102) is now being folded under the vertical support structure (130) via the secondary fold line (114) to create a support leg for the freestanding configuration. The engagement features (108) are being repositioned to connect with the base to create a self-supporting structure.

FIG. 2C illustrates a third step, showing the fully assembled easel-like display stand configuration. The first end portion (102) has now been completely folded around and under, with the engagement features (108) now coupled to the base. The reconfigured sheet material (100) forms a triangular support structure capable of standing independently on a flat surface. This freestanding configuration provides temporary display capability for the bouquet between vehicle transport and placement in a permanent vase, extending the utility of the bouquet holder device beyond its primary vehicle transport function.

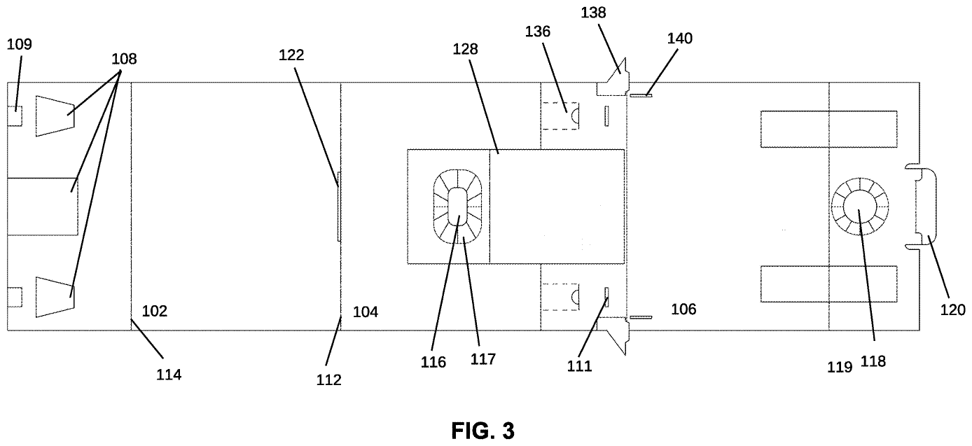

Referring to FIG. 3, a detailed plan view of the example foldable sheet material (100) in an unfolded, flat configuration is illustrated.

The foldable sheet material (100) is shown as a single continuous sheet divided into multiple portions by fold lines. Starting with the first end portion (102) on the left, including the engagement features (108) in the form of trapezoidal tabs and a central tab oriented the opposing direction, designed to interact with a vehicle seatbelt for lateral stability, and to secure to corresponding slots in the base in the easel configuration.

As this view provides more granular detail, more features are visible.

For example, it can be seen that sets of cutout finger tabs (117) and (110) surround the circumferences of both of the bouquet apertures (116) and (118). These tabs fold outwards when a large enough set of bouquet stems are passed through, allowing the apertures to apply a small inward pressure to the bouquet stems through a range of different bouquet sizes. It can also be seen that the first aperture (116) which forms the lower bouquet support, is of an oval shape having a greater width than the circular shape of the second aperture (118). This encourages the stems to flare out slightly at the bottom.

Also visible are a set of cutout slots (136) in the feet of the support structure (128) in the central portion (104) of the sheet (100). These slots (136) are what the triangular tabs of the engagement features (108) secure to in the easel configuration.

In a similar manner, a secondary set of stabilizing engagement tabs (109) can be seen which in turn slot into a second set of stabilizing slots (111) in the self-standing easel configuration, and a pair of stabilizing wing tabs (138) fold inwards and engage with corresponding slots (140) on the second end portion (106).

A person skilled in the art will understand that any number of such stabilizing features could be implemented in any suitable arrangement to complement and reinforce the primary structures described herein, and similarly that the precise shape and arrangement of the cutouts and folds could include any number of variations while still achieving the same effect within the spirit of the invention.

### Conclusion

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the bouquet holder of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A holder device comprising:
a foldable sheet material;
at least one engagement feature configured to engage with a vehicle seatbelt for lateral stability;
wherein the foldable sheet material is configured to extend from a vehicle seat into a vehicle footwell and form a vertical support structure that rests on a floor of the vehicle footwell; and
wherein the foldable sheet material comprises a plurality of apertures configured to vertically align when the foldable sheet material is in a folded configuration to receive and support a bouquet.

2. The holder device of claim 1, wherein the foldable sheet material comprises a first end portion, a middle portion, and a second end portion, wherein the first end portion, the middle portion, and the second end portion are integrally formed from a single sheet of material.

3. The holder device of claim 2, wherein the at least one engagement feature comprises a plurality of protruding tabs disposed at the first end portion, wherein each of the protruding tabs includes a cutout configured to capture the vehicle seatbelt when the bouquet holder device is installed.

4. The holder device of claim 2, wherein the first end portion comprises a horizontal portion configured to rest flat on a surface of the vehicle seat.

5. The holder device of claim 2, wherein the middle portion extends downward from the first end portion and is configured to descend into the vehicle footwell.

6. The holder device of claim 2, wherein the second end portion comprises a securing tab configured to fold back toward the middle portion and engage with an aperture in the foldable sheet material to lock the bouquet holder device in the folded configuration.

7. The holder device of claim 2, wherein the middle portion comprises a plurality of secondary fold lines dividing the middle portion into at least three sub-portions, wherein the sub-portions are configured to fold relative to each other to create a rigid vertical support structure.

8. The holder device of claim 1, wherein the plurality of apertures comprises a first aperture located in a middle region of the foldable sheet material and a second aperture located in a lower region of the foldable sheet material when the bouquet holder device is in the folded configuration.

9. The holder device of claim 8 wherein the first aperture is a sunburst-patterned aperture having a plurality of flexible fingers configured to adaptively accept stems of various diameters.

10. The holder device of claim 8, wherein the second aperture is a sunburst-patterned aperture having a plurality of flexible fingers configured to adaptively accept stems of various diameters.

11. The holder device of claim 8, wherein a distance between the first aperture and the second aperture when in the folded configuration is predetermined to provide optimal support for standard bouquet configurations.

12. The holder device of claim 1, wherein the foldable sheet material includes a primary crease line extending perpendicular to a length of the foldable sheet material, the primary crease line being positioned to align with an edge of the vehicle seat where the vehicle seat meets the vehicle footwell.

13. The holder device of claim 12, wherein the primary crease line includes an aperture configured to receive a securing tab when the bouquet holder device is in the folded configuration.

14. The holder device of claim 1, wherein the foldable sheet material is formed from a material selected from the group consisting of corrugated cardboard, plastic sheeting, paperboard, fiberboard, and combinations thereof.

15. The holder device of claim 1, wherein the foldable sheet material is reconfigurable from the folded configuration for vehicle use into an easel-like freestanding display stand configuration for use outside of a vehicle.

16. The holder device of claim 15, wherein the easel-like freestanding display stand configuration is formed by refolding portions of the foldable sheet material that engages with the vehicle seatbelt to create a support leg structure.

17. The holder device of claim 1, wherein the bouquet holder device is configured to stand independently without support from additional objects when in the folded configuration.

18. The holder device of claim 1, wherein a lower portion of the vertical support structure is configured to rest flat on the floor of the vehicle footwell to provide vertical stability to the bouquet holder device.

19. The holder device of claim 1, wherein at least a portion of the foldable sheet material includes a blank space configured for receiving printed matter, personalization, or advertising.

20. The holder device of claim 1, wherein the foldable sheet material is configured to accept and support a thin vase containing bouquet stems.
